(19) United States
(12) Patent Application Publication
(10) Pub. No.: US 2022/0312533 A1
(43) Pub. Date: Sep. 29, 2022

(54) Network-Based Interface Setup Assistance

(71) Applicant: Telefonaktiebolaget LM Ericsson (publ), Stockholm (SE)

(72) Inventors: Markus Drevö, Linköping (SE); Paul Schliwa-Bertling, Ljungsbro (SE); Icaro L. J. Da Silva, Solna (SE)

(21) Appl. No.: 17/624,894

(22) PCT Filed: Jul. 10, 2020
(86) PCT No.: PCT/SE2020/050724

§ 371 Date: Jan. 5, 2022

Related U.S. Application Data
(60) Provisional application No. 62/872,658, filed on Jul. 10, 2019.

(51) Int. Cl. H04W 76/19; H04W 12/06

(52) U.S. Cl. CPC H04W 76/19; H04W 12/06; H04W 92/20

(57) ABSTRACT

A RAN node (110b) receives, from a UE (130), a request for an RRC connection that the UE (130) previously had with a different RAN node (110a) that is not a radio neighbor of the RAN node (110b), and triggers an AMF (120) to provide an identity of one of the RAN nodes (110a, 110b) to the other of the RAN nodes (110a, 110b). The AMF (120) receives the request and provides the identity of the one of the RAN nodes (110a, 110b) to the other of the RAN nodes (110a, 110b) accordingly.

### RELATED APPLICATIONS

This application claims priority to U.S. Application No. 62/872,658, filed 10 Jul. 2019, the disclosure of which is hereby incorporated by reference in its entirety.

### TECHNICAL FIELD

The present application generally relates to wireless communication networks, and more particularly relates to setting up an interface between Radio Access Network (RAN) nodes of a wireless communication network.

### BACKGROUND

In the context of standardization of the 5th Generation (5G) of wireless cellular networks, the Third Generation Partnership Project (3GPP) introduced a new Radio Resource Control (RRC) state, i.e., the RRC_INACTIVE state.

RRC_INACTIVE is a state in which a User Equipment (UE) remains in the CM-CONNECTED state, and can move within an area configured by the Next Generation (NG) RAN (NG-RAN) (i.e., the RAN-based Notification Area (RNA)) without notifying the NG-RAN. In RRC_INACTIVE, the last serving gNodeB (gNB) node keeps the UE context and the UE-associated NG connection with the serving Access and Mobility Function (AMF) and User Plane Function (UPF).

If the last serving gNB receives downlink (DL) data from the UPF or DL UE-associated signaling from the AMF (except the UE Context Release Command message) while the UE is in RRC_INACTIVE, that gNB pages in the cells corresponding to the RNA and may send Xn Application Protocol (XnAP) RAN Paging to neighbor gNB(s) if the RNA includes cells of neighbor gNB(s).

If the UE accesses a gNB other than the last serving gNB, the receiving gNB triggers the XnAP Retrieve UE Context procedure to get the UE context from the last serving gNB and may also trigger an Xn User plane (Xn-U) Address Indication procedure including tunnel information for potential recovery of data from the last serving gNB. The new gNB determines the old gNB that holds UE's context by examining the UE's resume identity Inactive Radio Network Temporary Identifier (I-RNTI) presented by the UE during the resume procedure (e.g., as described in 3GPP TS 38.300 v15.6.0). Upon successful UE context retrieval, the receiving gNB performs slice-aware admission control if slice information is received, becomes the serving gNB, and further triggers the Next Generation Application Protocol (NGAP) Path Switch Request and applicable RRC procedures. After the path switch procedure, the serving gNB triggers release of the UE context at the last serving gNB by means of the XnAP UE Context Release procedure.

If the UE is not reachable at the last serving gNB, the gNB fails any AMF initiated UE-associated class 1 procedure which allows the signaling of unsuccessful operation in the respective response message. The gNB also triggers the Non-Access Stratum (NAS) Non-Delivery Indication procedure to report the non-delivery of any NAS Packet Data Unit (PDU) received from the AMF for the UE.

If the UE accesses a receiving gNB other than the last serving gNB and the receiving gNB does not find a valid UE Context, the receiving gNB can establish a new RRC connection instead of resuming the previous RRC connection. Similarly, if the serving AMF changes, UE context retrieval will fail and a new RRC connection needs to be established.

A UE in the RRC_INACTIVE state is required to initiate an RNA update procedure when it moves out of the configured RNA. When receiving an RNA update request from the UE, the receiving gNB triggers the XnAP Retrieve UE Context procedure to get the UE context from the last serving gNB and may decide to send the UE back to the RRC_INACTIVE state, move the UE into RRC_CONNECTED state, or send the UE to RRC_IDLE. When periodic RNA updates are being requested, if the last serving gNB decides not to relocate the UE context, the last serving gNB fails the Retrieve UE Context procedure and sends the UE back to RRC_INACTIVE or to RRC_IDLE directly by an encapsulated RRCRelease message.

The standard supports mechanisms to automatically establish Xn links between NG-RAN nodes. When an unknown Physical Cell Identifier (PCI) is detected, the node to which the UE is RRC connected can request information such as gNB Identifier and Tracking Area Identity (TAI). The gNB Identifier and the TAI are sufficient to route messages between the nodes via the AMF to establish the Xn interface. By exchanging Transport Network Layer (TNL) information for a potential Xn link, any of the two nodes can initiate establishment of the Xn link. According to known techniques, Xn links established in this way have always been between NG-RAN nodes which have some overlap in radio coverage.

### SUMMARY

Due to a lack of information about the old RAN node, a traditional RRC resume procedure can fail for a UE moving from an old RAN node (i.e., a previous RAN node) to a new RAN node (i.e., a subsequent RAN node). Embodiments of the present disclosure improve upon traditional RRC resume procedures, e.g., by avoiding or preventing such failures. Thus, embodiments of the present disclosure generally relate to establishing a link between RAN nodes (e.g., gNBs). According to one or more such embodiments, the new RAN node retrieves, from the Core Network (CN), information about the old RAN node that is useful for performing autonomous configuration of the Xn interface between the old and new RAN nodes.

Embodiments of the present disclosure include a method, implemented by a RAN node. The method comprises receiving, from a UE, a request for an RRC connection that the UE previously had with a different RAN node that is not a radio neighbor of the RAN node. The method further comprises triggering an AMF to provide an identity of one of the RAN nodes to the other of the RAN nodes. In some such embodiments, the method further comprises establishing an Xn interface with the different RAN node. In some such embodiments, triggering the AMF to provide the identity of one of the RAN nodes to the other of the RAN nodes comprises triggering the AMF to provide the identity of the different RAN node to the RAN node. Further, establishing the Xn interface with the different RAN node comprises using the identity of the different RAN node to establish the Xn interface. In some such embodiments, the method further comprises receiving the identity of the different RAN node in a Next Generation Application Protocol (NGAP) message.

In some embodiments, triggering the AMF to provide the identity of one of the RAN nodes to the other of the RAN nodes comprises triggering the AMF to provide the identity of the RAN node to the different RAN node, and the method further comprises receiving information regarding the different RAN node from the different RAN node in response to the triggering. The method further comprises establishing the Xn interface with the different RAN node comprises using the information regarding the different RAN node to establish the Xn interface.

In some embodiments, triggering the AMF to provide the identity comprises sending an INITIAL UE message to the AMF.

In some embodiments, triggering the AMF to provide the identity comprises sending a Message Authentication Code-Integrity (MAC-I) received from the UE to the AMF.

In some embodiments, the method further comprises triggering the AMF to provide the identity comprises sending a Physical Cell Identifier (PCI) received from the UE to the AMF.

In some embodiments, the method further comprises triggering the AMF to provide the identity comprises sending a Radio Network Temporary Identifier (RNTI) received from the UE to the AMF.

In some embodiments, the method further comprises receiving, from the AMF, notice that the UE has been verified as legitimate in response to the triggering.

Other embodiments include a method implemented by an AMF node. The method comprises receiving a request from a RAN node attempting to provide a UE with an RRC connection that the UE previously had with a different RAN node, the request requesting that the AMF node provide an identity of one of the RAN nodes to the other of the RAN nodes. The method further comprises providing the identity of the one of the RAN nodes to the other of the RAN nodes.

In some embodiments, providing the identity of one of the RAN nodes to the other of the RAN nodes comprises providing the identity of the different RAN node to the RAN node. In some such embodiments, providing the identity of the different RAN node to the RAN node comprises providing the identity of the different RAN node in a Next Generation Application Protocol (NGAP) message (e.g., in an INITIAL UE CONTEXT SETUP REQUEST message).

In some embodiments, providing the identity of one of the RAN nodes to the other of the RAN nodes comprises providing the identity of the RAN node to the different RAN node.

In some embodiments, receiving the request from the RAN node comprises receiving an INITIAL UE message from the RAN node.

In some embodiments, receiving the request from the RAN node comprises receiving a Message Authentication Code-Integrity (MAC-I) from the RAN node.

In some embodiments, receiving the request from the RAN node comprises receiving a Physical Cell Identifier (PCI) from the RAN node.

In some embodiments, receiving the request from the RAN node comprises receiving a Radio Network Temporary Identifier (RNTI) from the RAN node.

In some embodiments, the method further comprises sending a UE verification request to the different RAN node. The UE verification request comprises information received in the request from the RAN node requesting that the AMF node provide the identity of one of the RAN nodes to the other of the RAN nodes. Further, providing the identity of the one of the RAN nodes to the other of the RAN nodes is responsive to receiving notice from the different RAN node that the UE has been verified as legitimate.

Other embodiments include a different method implemented by a Radio Access Network (RAN) node. The method comprises receiving, from an AMF, an identity of a different RAN node that is attempting to provide a UE with an RRC connection that the UE previously had with the RAN node. The method further comprises sending information useful for establishing an Xn interface with the RAN node to the different RAN node.

In some embodiments, receiving the identity of the different RAN node from the AMF comprises receiving the identity of the different RAN node in a Next Generation Application Protocol (NGAP) message (e.g., in an INITIAL UE CONTEXT SETUP REQUEST message).

In some embodiments, the method further comprises receiving a Message Authentication Code-Integrity (MAC-I) from the AMF.

In some embodiments, the method further comprises receiving a Physical Cell Identifier (PCI) from the AMF.

In some embodiments, the method further comprises receiving a Radio Network Temporary Identifier (RNTI) from the AMF.

In some embodiments, the method further comprises receiving a UE verification request from the AMF, the UE verification request comprising information received by the AMF from the different RAN node. The method further comprises verifying that the UE is legitimate based on the information comprised in the UE verification request. The method further comprises sending notice to the AMF that the UE is legitimate and receiving the identity of the different RAN node in response.

Other embodiments include a RAN node. The RAN node is configured to receive, from a UE, a request for an RRC connection that the UE previously had with a different RAN node that is not a radio neighbor of the RAN node. The RAN node is further configured to trigger an AMF to provide an identity of one of the RAN nodes to the other of the RAN nodes.

In some embodiments, the RAN node is further configured to perform the method in accordance with any of the method embodiments described above with respect to a RAN node.

In some embodiments, the RAN node comprises processing circuitry and interface circuitry communicatively connected to the processing circuitry. The processing circuitry is configured to receive, from the UE via the interface circuitry, the request for the RRC connection that the UE previously had with the different RAN node, and trigger the AMF to provide the identity of one of the RAN nodes to the other of the RAN nodes. In some such embodiments, the processing circuitry is further configured to perform the method in accordance with any of the method embodiments described above with respect to a RAN node.

Other embodiments include an AMF node. The AMF node is configured to receive a request from a RAN node attempting to provide a UE with an RRC connection that the UE previously had with a different RAN node. The request requests that the AMF node provide an identity of one of the RAN nodes to the other of the RAN nodes. The AMF node is further configured to provide the identity of the one of the RAN nodes to the other of the RAN nodes.

In some embodiments, the RAN node is further configured to perform the method in accordance with any of the method embodiments described above with respect to an AMF.

In some embodiments, the RAN node comprises processing circuitry and interface circuitry communicatively connected to the processing circuitry. The processing circuitry is configured to receive, via the interface circuitry, the request from the RAN node attempting to provide the UE with the RRC connection that the UE previously had with the different RAN node. The request requests that the AMF node provide an identity of one of the RAN nodes to the other of the RAN nodes. The processing circuitry is further configured to provide the identity of the one of the RAN nodes to the other of the RAN nodes. In some such embodiments, the processing circuitry is further configured to perform the method in accordance with any of the method embodiments described above with respect to an AMF.

Yet other embodiments include a RAN node configured to receive, from an AMF, an identity of a different RAN node that is attempting to provide a UE with an RRC connection that the UE previously had with the RAN node. The RAN node is further configured to send information useful for establishing an Xn interface with the RAN node to the different RAN node.

In some embodiments, the RAN node is further configured to perform the method of any of the method embodiments described above with respect to a RAN node.

In some embodiments, the RAN node comprises processing circuitry and interface circuitry communicatively connected to the processing circuitry. The processing circuitry is configured to receive, from the AMF via the interface circuitry, the identity of the different RAN node that is attempting to provide the UE with the RRC connection that the UE previously had with the RAN node, and send information useful for establishing the Xn interface with the RAN node to the different RAN node via the interface circuitry. In some such embodiments, the processing circuitry is further configured to perform the method in accordance with any of the method embodiments described above with respect to a RAN node.

Other embodiments include a computer program, comprising instructions which, when executed on processing circuitry of a network node (e.g., a RAN node, an AMF node), cause the processing circuitry to carry out the method in accordance with any of the methods described above.

Other embodiments include a carrier containing the computer program of the preceding claim. The carrier is one of an electronic signal, optical signal, radio signal, or computer readable storage medium.

Yet other embodiments are discussed in greater detail below and shown in the accompanying figures.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a RAN Node 110, generally, as opposed to discussion of particular instances of RAN Nodes 110a, 110b, 110c).

FIGS. 1A and 1B are schematic diagrams illustrating examples of a radio communication environment, according to one or more embodiments of the present disclosure.

FIG. 2 is a table illustrating an example structure of an UPLINK RAN CONFIGURATION TRANSFER message, according to one or more embodiments of the present disclosure.

FIG. 3 is a table illustrating an example structure of a SON Configuration Transfer Information Element (IE), according to one or more embodiments of the present disclosure.

FIG. 4 is a table illustrating an example structure of a Global gNB ID IE, according to one or more embodiments of the present disclosure.

FIG. 5 is an Abstract Syntax Notation One (ASN.1) definition of an example RRCResumeRequest1 message, according to one or more embodiments of the present disclosure.

FIG. 6 is an ASN.1 definition of an example I-RNTI-Value IE, according to one or more embodiments of the present disclosure.

FIG. 7 is an ASN.1 definition of an example RRCResumeRequest message, according to one or more embodiments of the present disclosure.

FIG. 8 is an ASN.1 definition of an example ShortI-RNTI-Value IE, according to one or more embodiments of the present disclosure.

FIGS. 9-14 are signaling diagrams illustrating example signaling between network nodes, according to one or more embodiments of the present disclosure.

FIG. 15 is a table illustrating an example structure of an INITIAL UE MESSAGE, according to one or more embodiments of the present disclosure.

FIGS. 16A, 16B, and 16C are parts of a table that together illustrate an example structure of an INITIAL CONTEXT SETUP REQUEST message, according to one or more embodiments of the present disclosure.

FIGS. 17-19 are flow diagrams illustrating example methods, according to one or more embodiments of the present disclosure.

FIG. 20 is a schematic block diagram illustrating an example RAN node, according to one or more embodiments of the present disclosure.

FIG. 21 is a schematic block diagram illustrating an example AMF node, according to one or more embodiments of the present disclosure.

### DETAILED DESCRIPTION

As discussed above, when a UE moves from an old RAN node to a new RAN node, the lack of information about the old RAN node at the new RAN node can cause a traditional RRC resume procedure to fail. Accordingly, embodiments of the present disclosure generally relate to RRC resume procedures that, at least in some embodiments, avoid or prevent such failures. In some embodiments, the new RAN node indicates to the CN (e.g. to an AMF and/or SMF) a request for retrieval of supplementary information useful for the new RAN node to successfully establish a link to the old RAN node, successfully conclude an RRC resume procedure, enhance RAN node resource management, and/or otherwise enhance UE mobility.

Such a request from the new RAN node to the CN may comprise additional information, such as content that has been transmitted by the UE in an RRC Resume Request (e.g., to which a fallback was sent in response), RRC Setup Complete, and/or a NAS PDU (e.g., a registration update request).

Thus, one or more embodiments of the present disclosure are based on retrieval of information from the AMF about the old RAN node useful for the new RAN node to perform autonomous configuration of the Xn interface between these two RAN nodes.

It should be noted that, for purposes of explanation and providing clear examples, embodiments of the present disclosure will specifically discuss the Xn interface between RAN nodes such as gNBs or NG-RAN nodes. That said, the same or similar principles may be applied to other interfaces between other kinds of nodes, particularly with respect to RAN nodes, e.g., regardless of the Radio Access Technologies (RATs) involved.

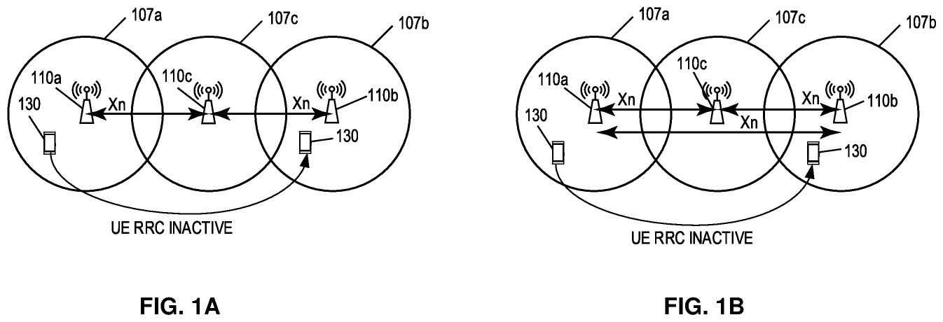

FIGS. 1A and 1B each illustrate the coverage areas 107a-c of three RAN nodes 110a-c, each of which has the same PLMN but different gNB IDs. RAN node 110a (with gNB ID 1, NG-RAN node address index 34, in this example) is an old RAN node, in the sense that it has an inactive RRC UE context. RAN node 110b (with gNB ID 3, NG-RAN node address index of 12, in this example) is a new RAN node, in that the UE 130 resumes connected mode in RAN node 110b and provides the RAN node 110b with an I-RNTI. RAN node 110c (with gNB ID 2, NG-RAN node address index 77, in this example) is a node having a coverage area that is geographically between RAN nodes 110a, 110b. Thus, there is some distance between RAN nodes 110a, 110b. All of the RAN nodes 110a-c have the same TAI in this example, but the PLMN in the TAI is not necessarily identical to the PLMN in the gNB IDs of the RAN nodes 110a-c according to other embodiments.

In FIG. 1A, the Xn interfaces established using Automatic Neighbor Relation (ANR) for connected mode UEs are depicted. However, a UE 130 in the RRC_INACTIVE state may move to a RAN node 110 that is not a radio neighbor. That is, a UE 130 in the RRC_INACTIVE state can move, without interacting with the network, to a RAN node 110b that does not provide geographically overlapping radio coverage with the previous RAN node 110a. For UEs where such mobility is common, it would be beneficial to establish Xn links between such nodes. Accordingly, embodiments of the present disclosure support an Xn link between RAN nodes 110a, 110b that do not have geographically overlapping radio coverage, as shown in FIG. 1B. Such embodiments may enable a UE 130 to move quickly through the coverage of a plurality of RAN nodes 110a-c.

In this example, RAN node 110b (i.e., the new RAN node) has a gNB ID of 3 and receives an I-RNTI comprising a RAN node address index of 34 for the first time and does not understand which node this is. In some embodiments, the new RAN node 110b may not even know whether it has Xn connectivity or not with the old RAN node 110a (i.e., the last serving node) where the UE Access Stratum (AS) Inactive context is stored.

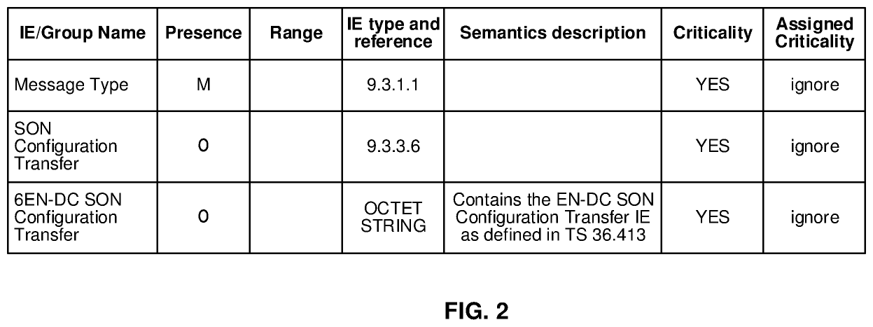

According to the NG-RAN Release 15 solution, to establish Xn connectivity between the old RAN node 110a that holds UE context and the new RAN node 110b, the new RAN node 110b uses the Configuration Transfer Procedure (see 3GPP TS 38.413 v15.3.0). According to such embodiments, the new RAN node 110b uses an UPLINK RAN CONFIGURATION TRANSFER message to contact the old RAN node 110a (also referred to in this procedure as a “Target RAN Node,” i.e., the node toward which the new RAN node 110b is targeting to establish the Xn interface with, not to be confused with the new RAN node 110b that is the target of the UE's 130 reconnection attempt). This UPLINK RAN CONFIGURATION TRANSFER message is sent via the AMF, and has a structure, e.g., as shown in the table of FIG. 2.

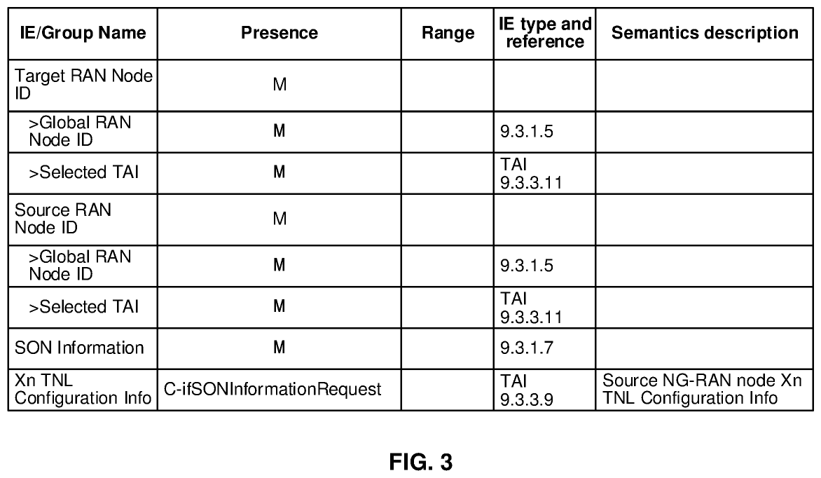

The UPLINK RAN CONFIGURATION TRANSFER message includes a SON Configuration Transfer IE. This IE comprises the configuration information used by, e.g., Self-Organizing Network (SON) functionality, and additionally includes the NG-RAN node identifier of the destination of this configuration information and the NG-RAN node identifier of the source of this information. The SON Configuration Transfer IE (according to NG-RAN Release 15) has a structure, e.g., as shown in the table of FIG. 3.

As shown in FIG. 3, the presence of the Xn TNL Configuration Info IE depends on whether the condition labeled “ifSONlnformationRequest” is met. According to this condition, the Xn TNL Configuration Info IE is present if the SON Information IE contains the SON Information Request IE set to “Xn TNL Configuration Info.”

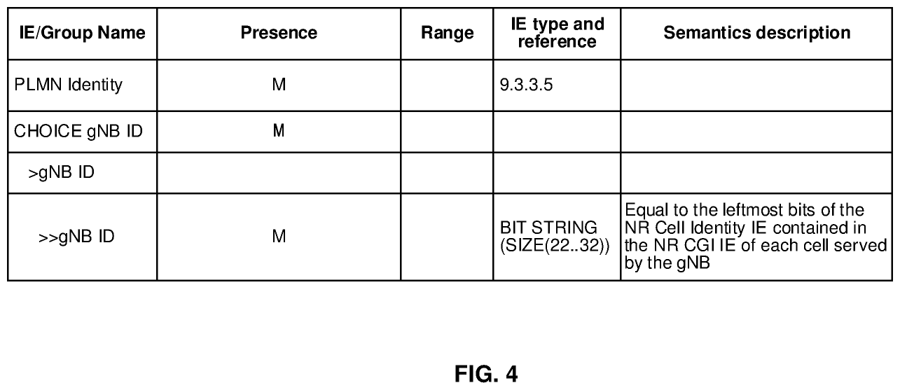

As can be seen from FIG. 3, for the routing of the Uplink RAN Configuration message, the Target RAN Node ID (i.e. the ID of the RAN node 110a toward which the Xn interface to be configured) is required. This ID comprises a Global RAN Node ID and a selected TAI (details regarding the Global RAN Node ID are specified, e.g., in 3GPP TS 38.413 v15.3.0). In a typical case of New Radio (NR) standalone deployments, for example, the Global Node RAN ID is a global gNodeB ID that contains a Public Land Mobile Network (PLMN) identity comprising 24 bits and an additional flexible structure comprising a bit string that may be from 22 to 32 bits, as shown, e.g., in the table of FIG. 4.

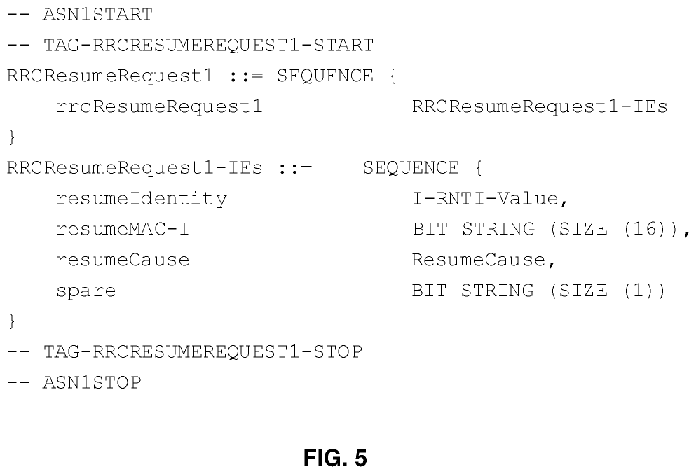

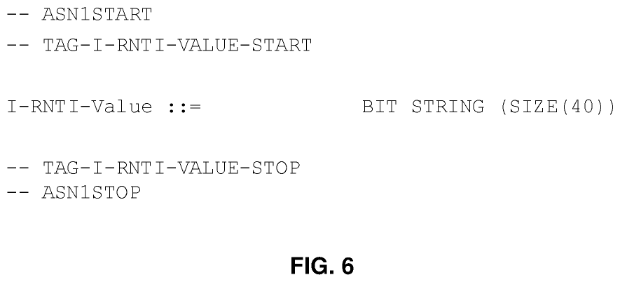

The Global Node RAN ID IE may be encoded as part of the I-RNTI and thus provided by the UE 130 to the new RAN node 110b during the resume procedure (e.g., as part of an RRC Resume Request or similar message such as RRCResumeRequest or RRCResumeRequest1). However, due to the limited addressing space of the I-RNTI, the PLMN part of the Global RAN Node ID is not likely to be included in at least some deployment scenarios. For example, if the target supports the reception of a long I-RNTI, a RRCResumeRequest1 message may be transmitted as shown in the example ASN.1 notation of FIG. 5. Correspondingly, the I-RNTI-Value IE may be as shown in the example ASN.1 notation of FIG. 6.

Even if a shorter version of the Global Node ID is be used (e.g., 22 bits for the gNB-ID and 24 bits for the PLMN for a total of 46 bits), it would still be larger than the 40 bits potentially allocated for the long I-RNTI. Further, even if truncation is performed, additional bits would still be required to encode a UE identifier. The lack of any bits for this purpose would only allow a given serving node (e.g., RAN node 110a) to suspend a single UE 130. Moreover, the selected TAI is generally not included in the I-RNTI and is thus not available at the new RAN node 110b.

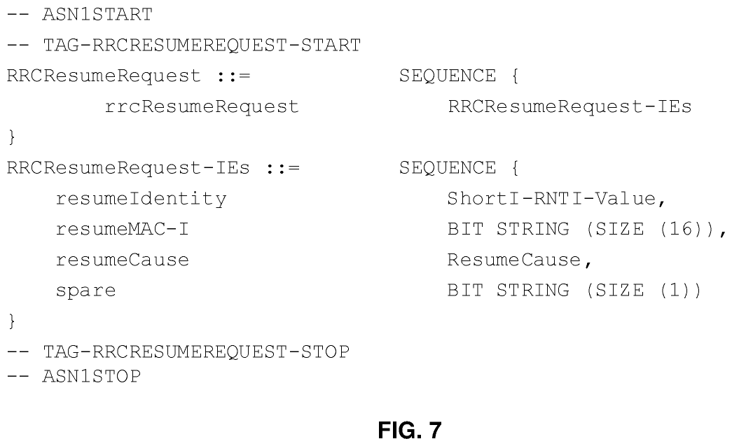

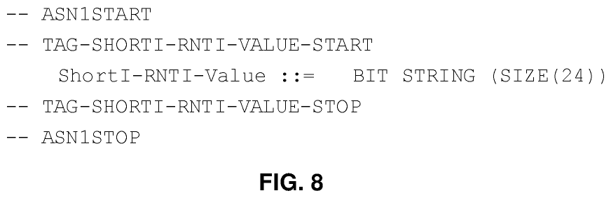

These signaling constraints are worse still in cases where a given target node only supports a short I-RNTI (e.g., due to some uplink (UL) coverage limitation). In such cases, the node may only decode RRCResumeRequest messages, i.e., with short I-RNTIs, which generally leaves a total of 24 bits for both UE and node identification, as shown in the ASN.1 notation of the example RRCResumeRequest message shown in FIG. 7. Correspondingly, the ShortI-RNTI-Value IE may, e.g., be as shown in the ASN.1 notation of FIG. 8.

Thus, there are numerous circumstances in which the configuration of the Xn interface between the new RAN node 110b and the old RAN node 110a cannot be conducted autonomously by the new RAN node using traditional techniques.

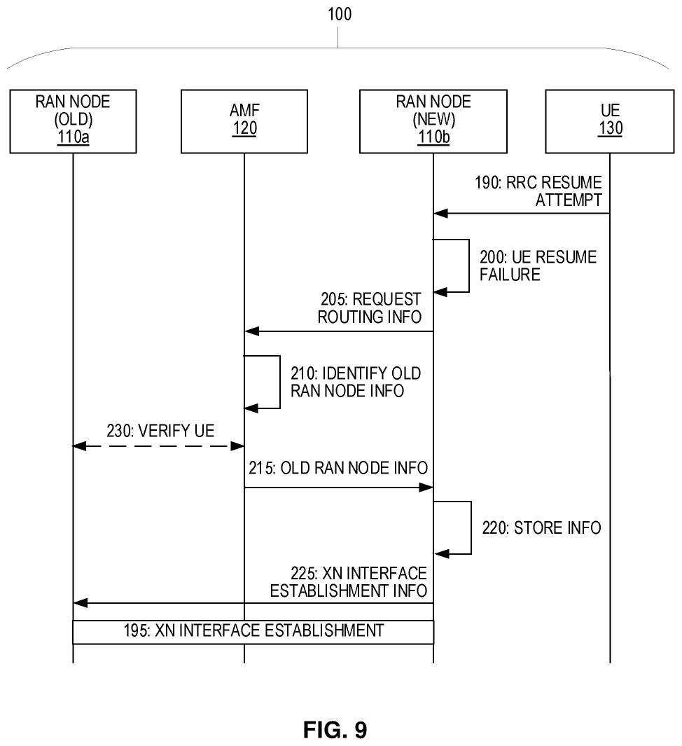

Accordingly, embodiments of the present disclosure include methods, signaling, devices, and systems, as shown in the example of FIG. 9. FIG. 9 is an example in which the new RAN node 110b learns how to contact the old RAN node 110a so that an Xn interface can be established between the RAN nodes 110a, 110b.

As shown in FIG. 9, a wireless communication network 100 comprises a plurality of network nodes. The network nodes include an old RAN node 110a, a new RAN node 110b, and an AMF 120. The network 100 also comprises a UE 130 that was previously served by the old RAN node 110a, and attempts to resume an RRC connection using new RAN Node 110b (step 190). The resume procedure fails at the new RAN node 110b due to the old RAN node 110a being unknown (e.g., the old RAN node 110a is nota neighbor of the new RAN node 110b, therefore the new RAN node 110b does not know of the existence of the old RAN node 110a) (step 200).

In response to the failed resume procedure, the new RAN node 110b (e.g., a gNodeB at which the UE 130 has tried to resume the RRC connection) indicates to the AMF 120 a request for old RAN node information useful for routing an UPLINK RAN CONFIGURATION MESSAGE to the old RAN node 110a (step 205). In some embodiments, this indication to the AMF 120 is received by the AMF 120 in a message, e.g., an Initial UE Message. In response to the request, the AMF 120 identifies the Global RAN Node ID and selected TAI of the old RAN Node 110a, which holds the NGAP association of the UE 130 (step 210).

In some embodiments, the request to the AMF 120 includes information transmitted by the UE 130 in the Reestablishment Request, e.g., the short Message Authentication Code-Integrity (MAC-I), the source PCI, and/or source C-RNTI. The MAC-I, for example, may enable the UE 130 to be verified as a legitimate UE (e.g., a UE 130 previously served by the old RAN node 110a and/or allowed to be connected to the wireless network 100). In such embodiments in which the MAC-I is included in the request to the AMF 120, the AMF 120 may forward the MAC-I to the old RAN node 110a so that the old RAN node 110a may verify whether UE 130 is a legitimate UE and report the result of that verification back to the AMF 120 (step 230). Alternatively, if the UE 130 is not verified, one or more of the nodes 110a, 110b, 120 may abandon the process, e.g., ignoring or omitting further steps 215, 220, 225, and/or 195 described below.

In some embodiments, the AMF responds to the new RAN node 110b with an indication that the UE's resume attempt might have been an unauthorized, fake, or malicious attempt (e.g., due to the UE 130 failing verification) (not shown in FIG. 2). Such embodiments enable verification of the UE 130 before setting up an Xn connection between the old RAN node 110a and the new RAN node 110b, e.g., in order to prevent an attack on the network 100 in which illegitimate UEs report fake I-RNTI(s) to the new RAN node 110b in an attempt to burden the network with unnecessary Xn connections.

The AMF 120 sends information concerning the old RAN Node 110a to the new RAN node 110b (step 215). In such embodiments in which verification of the UE 130 is performed, notice that the UE is legitimate may also be sent to the new RAN node 110b. Alternatively, the legitimacy of the UE 130 may be implied by the old RAN node 110a information being sent to the new RAN node 110b.

In some embodiments, the information is comprised in an NGAP message as part of an NGAP procedure. In some such embodiments, the information is sent in an INITIAL UE CONTEXT SETUP REQUEST message. If the old RAN node 110a verifies that UE 130 is legitimate (e.g., was actually previously served by the old RAN node 110a), the old RAN node 110a may indicate that to the AMF 120.

The new RAN Node 110b receiving the information stores the information received from the AMF 120 in the data that may not be associated with the UE that triggered the resume procedure (step 220). The new RAN Node 110b sends information to the old RAN node 110a comprising information useful to the old RAN Node 110a to establish the Xn interface (step 225). In some embodiments, this information comprises one or more TNL addresses. In some embodiments, the information is transferred using an Uplink RAN Configuration message. In some embodiments, the I-RNTI is also included in the information transferred to the old RAN node 110a, which may (for example) enable the old RAN node 110a to understand which UE 130 moved. Such embodiments may be useful for algorithms that learn UE movement patterns. As a result of the signaling shown in FIG. 2, the Xn interface is able to be established between the old RAN node 110a and the new RAN node 110b (step 195).

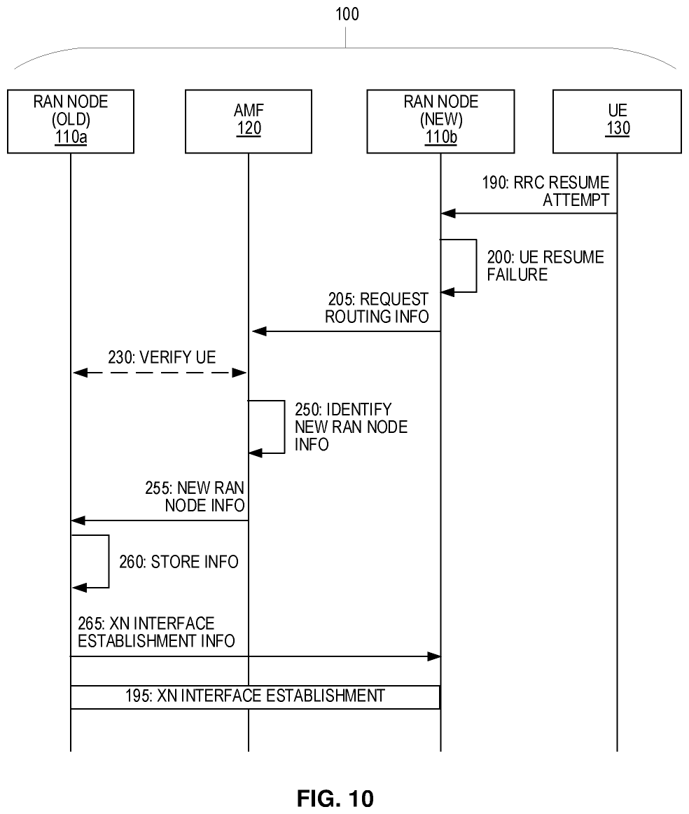

Other embodiments of the present disclosure include methods, signaling, devices, and systems, as shown in the example of FIG. 10. FIG. 10 is an example in which the new RAN node 110b triggers the AMF 120 to inform the old RAN node 110a of how the new RAN node 110b can be contacted, so that an Xn interface can be established between the RAN nodes 110a, 110b.

In the example of FIG. 10, steps 190, 200, and 205 (and 230, in some embodiments) are the same or substantially similar to those discussed above with respect to FIG. 9. In contrast to the example of FIG. 9 however, according to this example, in response to the request for routing information (e.g., in the form of an INITIAL UE MESSAGE), the AMF 120 identifies the Global RAN Node ID and selected TAI of the new RAN Node 110b (step 250) and sends this information to the old RAN node 110a (step 255) (provided that the UE 130 does not fail verification, if performed as described above).

In some embodiments, this information is sent to the old RAN node 110a in an NGAP message as part of an NGAP procedure. In some embodiments, the information is sent in a UE CONTEXT RELEASE COMMAND sent to the old RAN Node 110a. In some embodiments, the I-RNTI of the UE 130 is also forwarded to the old RAN Node 110a, e.g., to enable the old RAN Node 110a to clean up the context and/or track where its UEs are going. In some embodiments, after having learned that UE 130 has moved to new RAN node 110b, the old RAN node 110a may update its RNA configuration to include the new RAN node 110b as a candidate mobility target for UEs going forward.

The old RAN Node 110a receiving the information from the AMF 120 stores the information in the data that may not be associated with the UE 130 subject to the UE CONTEXT RELEASE COMMAND (or other signaling sent from the AMF 120) (step 260). The old RAN Node 110a sends information to the new RAN node 110b comprising information useful to the new RAN Node 110a to establish the Xn interface (step 265). In some embodiments, this information comprises one or more TNL addresses. In some embodiments, the information is transferred using an Uplink RAN Configuration message. In some embodiments, the I-RNTI is also included. As a result of the signaling shown in FIG. 10, the Xn interface is able to be established between the old RAN node 110a and the new RAN node 110b (step 195).

It should be noted that the resume MAC-I may be forwarded to the old RAN Node 110a to verify whether the UE 130 is legitimate in similar vein as discussed above with respect to FIG. 9. In such embodiments in which UE verification is performed, if the UE 130 is not verified, step 250, 255, 260, 265, and/or 195 may be ignored or omitted, and establishment of the Xn interface between the old RAN node 110a and new RAN node 110b is avoided. In some such embodiments, requiring that the UE 130 pass verification in order for the Xn connection to be established can avoid an attack on the network 100, e.g., in which fake UEs report fake I-RNTI(s) in order to burden the network with unnecessary Xn connections, thereby jeopardizing the security of the network 100.

In examples of both FIG. 9 and FIG. 10 as discussed above, the trigger is the detection of a resume attempt followed by a fallback procedure. However, embodiments of the present disclosure are not limited to being triggered by a resume fallback.

According to a first example of an additional or alternative trigger of the embodiments discussed above, the UE 130 in the RRC_INACTIVE state transitions to RRC_IDLE and tries to perform a transition to RRC_CONNECTED in a new RAN Node 110b. Such may occur, for example, during an abnormal transition to RRC_IDLE followed by a NAS recovery (e.g., a Registration Area Update) due to a failure case, such as when the UE 130 triggers a RAN Notification Area (RNA) Update in the target gNodeB but that fails and/or when timer T380 expires while the UE is out of coverage. Alternatively, this type of trigger may occur if the UE 130 is in the RRC_INACTIVE state and receives a CN paging message (e.g., a paging message with a CN identifier). In any of these cases, upon transitioning through the RRC_IDLE state (e.g., transmitting an RRC Setup Request or similar message, receiving an RRC Setup message, and transmitting an RRC Setup Complete message with a NAS PDU), the new RAN Node 110b triggers the method, e.g., by requesting that the AMF 120 indicate information regarding a last serving node (i.e., the old RAN Node 110a) for that UE 130, if any exists. To facilitate the triggering of this, embodiments also comprise a new indication from the UE 130 that during the transition from IDLE to CONNECTED, the NAS recovery indicates that the UE 130 was in INACTIVE state and had an abnormal transition to IDLE. According to the example of FIG. 9, that indication may trigger the new RAN node 110b to request that the AMF 120 provide information regarding the last serving node (i.e., information regarding the old RAN Node 110a, which may still hold a UE Context) so that Xn interface setup may be triggered. According to the example of FIG. 10, that indication may trigger the new RAN node 110b to request that information of the new Node 110b be forwarded by the AMF to the last serving RAN node 110a.

Another example of a trigger of embodiments in accordance with the examples illustrated in FIGS. 9 and 10 include a UE 130 in the CONNECTED state triggering a reestablishment procedure towards a target cell served by a new RAN node 110b (e.g., in response to a Radio Link Failure (RLF)). In that case, upon receiving the PCI and Cell RNTI (C-RNTI) of the old RAN node 110a (i.e., the last serving cell) the UE 130 was connected to in an RRC Reestablishment Request message (or similar message), the new RAN node 110b determines that it is not able to fetch the UE context, due to the lack of Xn (or any other inter-node) connectivity with the old RAN node 110a. In that case, the new RAN node 110b may send an RRC Setup message in response to the UE 130 and get a NAS PDU in response in an RRC Setup Complete message.

Another example of a trigger of embodiments discussed above includes when a UE 130 in CONNECTED state abnormally transitions to IDLE and tries to perform a transition to CONNECTED at a new RAN node 110b. This trigger may occur, for example, due to a failed reestablishment procedure (e.g., expiry of timer T301 and/or expiry of timer T311). In some such embodiments, upon transitioning via IDLE (e.g., transmitting an RRC Setup Request or similar message, receiving an RRC Setup message, and transmitting an RRC Setup Complete message with a NAS PDU), the new RAN node 110b requests that the AMF 120 indicate information regarding the last serving node for that UE (i.e., the old RAN Node 110a), if such exists (e.g., as discussed above with respect to FIG. 9). To facilitate the triggering of this process, a new indication from the UE 130 to the network in this IDLE to CONNECTED transition may be transmitted upon failed reestablishment or expiry of timer T311 indicating that the UE was in CONNECTED state and had an abnormal transition to IDLE. Receipt of this message by the new RAN Node 110b may indicate that information regarding the old RAN Node 110a (which may still hold a UE Context) may be available upon request to the AMF 120 so that Xn interface setup may be triggered between the new RAN Node 110b and the old RAN Node 110a (or according to embodiments consistent with FIG. 10, the information of new RAN Node may be forwarded to the old RAN node 110a). According to some embodiments, the new RAN node 110b may retrieve an RLF report to try to understand what has happened.

Note that the signaling from the new RAN node 110b to the AMF 120 may include information comprised in the above-discussed RRC Resume Request message, RRC Reestablishment Request, or similar message from the UE 130. For example, the transmitted I-RNTI may be used at the AMF 120 to facilitate the retrieval at the AMF 120 of information regarding the old RAN node 110a.

Further, in some embodiments, the new RAN node 110b may inform the AMF 120 of the exact cell in which the UE 130 has tried to resume. For example, this information may be included in, or provided contemporaneously with, the request for information useful for routing messages between the RAN nodes 110a, 110b (step 205). This information may enhance or enable UE verification by the old RAN node 110a, since target cell information is used in the calculation of the resume MAC-I. Thus, the old RAN node 110a may, in some embodiments, calculate a MAC-I from this target cell information and compare the result to a MAC-I received from the AMF 120 to determine whether the UE 130 is legitimate. As discussed above, information about the target cell may also enable the old RAN Node 110a to configure RAN Areas and/or consider the new RAN node 110b as a candidate mobility target for UEs in the future.

In some embodiments, the AMF 120 may correlate a received I-RNTI of the UE 130 with information in a NAS PDU so that the AMF 120 can identify the old RAN node 110a based on the I-RNTI should that I-RNTI be received by the AMF 120 in further requests. In some embodiments, this correlation is performed during Xn connectivity setup.

Other embodiments of the present disclosure are directed to handling failure scenarios at the AMF 120. In a first such embodiment, the AMF 120 receives from the new RAN node 110b a request to report information regarding the old RAN node 110a (i.e., the UE's last serving node, which is associated to the UE's NG-RAN connection) and determines that the NG-RAN connection for that UE 130 does not exist. This may occur, for example, when the AMF 120 and/or the old RAN node 110a has previously deleted and/or released the AS Inactive context of the UE 130 (e.g. due to the lack of memory, expiry of periodic RNA update timer such as the T380 or other similar circumstances). In such embodiments, upon receiving the request, the AMF 120 may be refrain from providing the old RAN node's 110a information to the new RAN node 110b (as in FIG. 9, step 215), or refrain from forwarding the new RAN node's 110b information to the old RAN Node 110a (as in FIG. 10, step 255). Indeed, in some embodiments, the AMF 120 may be unable to take such actions, as this information may not be known at the AMF 120. Instead, the AMF 120 may provide a failure indication to the new RAN node 110b.

In a second such embodiment, to avoid a failure, upon a removal, release, and/or delation of the AS Inactive context of the UE 130, (e.g., due to the lack of memory, expiry of periodic RNA update timer such as the T380 timer, etc.) and the corresponding tearing down of the NG-RAN interface, the AMF 120 may nonetheless store information regarding the old RAN node 110a for the UE 130, despite remove of that UE's context. For example, the AMF 120 may retain this information in case the UE attempts to resume at another RAN node (e.g., the new RAN node 110b). Thus, Xn connectivity between the old RAN node 110a and the new RAN node 110b may nonetheless be established in a manner similar to the example given in FIG. 9 despite the UE context having been released. Indeed, the old RAN node 110a may be implemented to suspend the UE 130 and immediately delete the UE's context in reliance on the AMF 120 retaining information about the old RAN node's 110a that can be used for later setup of the Xn connectivity between the RAN nodes 110a, 110b. In some such embodiments, this information may be retained at the AMF 120 fora predetermined amount of time, after which the information is deleted. For example, a timer may be started upon receipt of the old RAN node's 110a information, and in response to that timer expiring, the AMF 120 may delete the old RAN node's 110a information.

In a third such embodiment, the AMF 120 performs failure handling using the I-RNTI of the UE 130. As discussed above, AMF 120 may receive this I-RNTI in a request for the old RAN node's 110a information. In response, the AMF 120 may derive a node identifier of the old RAN node 110a, e.g. using a mapping between node ID and I-RNTI. For example, the AMF 120 may maintain a mapping between a gNodeB ID of the old RAN node 110a and some number of bits of the I-RNTI (e.g., the leftmost or rightmost bits), which may be provided to the new RAN node 110b (e.g., as in FIG. 9, step 215) or used to identify the old RAN node 110a so that information about the new RAN node 110b may be forwarded to the old RAN node 110a (e.g., as in FIG. 10, steps 250, 255). In some such embodiments, a node suspending the UE 130 (e.g., the old RAN node 110a) indicates the I-RNTI of the UE 130 being suspended to the AMF 120 so that even when the NG-RAN is torn down, the AMF 120 is aware of a mapping between the I-RNTI that was received and the node for which Xn connection needs to be setup (e.g., the old RAN node 110a).

In view of the above (and as will be further evidenced below), one or more embodiments of the present disclosure enable automatic configuration of a new Xn interface based on a UE's 130 mobility patterns when that UE 130 is configured in the RRC_INACTIVE state. Such embodiments may avoid certain manual and/or computational work. Such work may not only be wasteful of manual and/or computational resources, but may also take longer and/or be more prone to errors.

Additionally or alternatively, one or more embodiments of the present disclosure are robust in that they provide greater handling of the potential error cases that may occur, and/or cover additional or alternative cases in which Xn connectivity may be useful. Among such cases include a fallback from resume, a fallback from re-establishment, CN paging, and NAS recovery, to name a few examples.

Automation of Xn interface setup in support of UEs that have entered the Inactive state in accordance with one or more embodiments described herein may also enable the network 100 to expand the number of nodes covering an RNA and its neighborhood since it would be more likely that setup of an Xn interface between RAN nodes 110a, 110b will be useful because establishment of the Xn interface may be based on a report from an actual UE 130 in the network 100 (e.g., as part of the RRC resume attempt).

Additionally or alternatively, one or more embodiments provide security mechanisms in which a UE 130 transmitting a resume request can be verified, e.g., so that when the UE 130 attempts to resume a connection (e.g., followed by fallback), the Xn interface is setup only if the UE can be verified. As discussed above, this verification may be performed using the resume MAC-I.

Consistent with one or more embodiments described above, the following embodiments will provide greater detail into particular aspects, features and/or variations within the scope of this disclosure.

It should be noted that when a UE 130 in RRC_INACTIVE state leaves its currently registered RNA, it typically performs an RNA Update (RNAU) procedure with the new RAN node 110b. The absence of an Xn interface between the new and old RAN nodes 110a, 110b has traditionally caused the resume procedure to fail. As a consequence of the UE 130 receiving an RRCSetup message as a response to its RRCResumeRequest message, the UE 130 consequently performs a so-called “NAS recovery procedure” toward an AMF 120 (e.g. a Tracking Area Update or Registration Update). Embodiments of the present disclosure serve as an alternative to such a series of events.

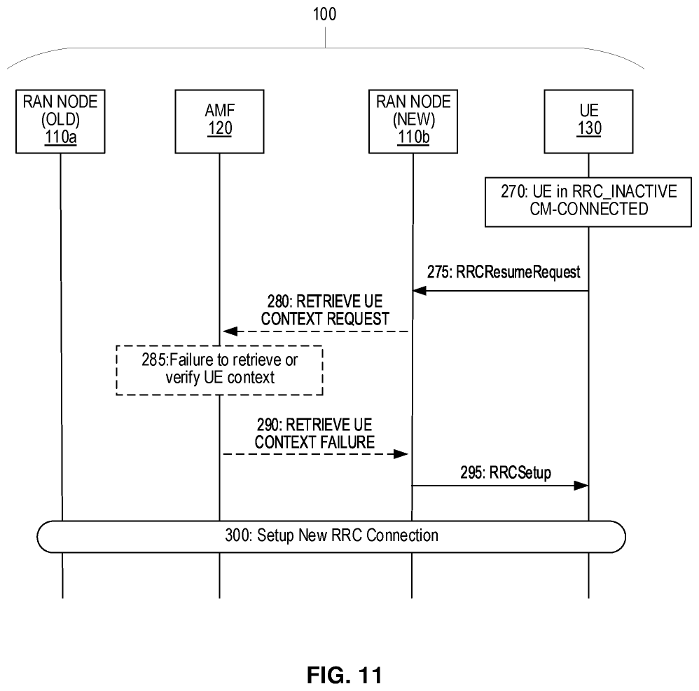

FIG. 11 illustrates an embodiment in which UE context retrieval fails during a transition of a UE 130 from the RRC_INACTIVE state to the RRC_CONNECTED state. Having discussed FIG. 11 as depicted, it will subsequently be explained how this process can be advantageously be modified.

Consistent with the example of FIG. 11, the UE context retrieval may fail if, among other things, the new RAN node 110b identifies internally that it cannot resume that connection on its own (i.e., without requesting information from another node). For example, in response to a resume request, the new RAN node 110b may fail to identify any of its neighbors if the new RAN node 110b does not have Xn connectivity with any other node, and/or cannot identify the old RAN node 110a based on the I-RNTI of the UE 130.

As shown in FIG. 11, the UE 130 has an RRC state of RRC_INACTIVE and a Connection Management (CM) state of CM-CONNECTED (step 270). From this state, the UE 130 provides the I-RNTI allocated to the UE 130 by the old RAN node 110a to the new RAN node 110b (either or both of which may be gNBs) (step 275). The new RAN node 110b, if able to resolve the gNB identity contained in the I-RNTI, requests that the old RAN node 110a (e.g., the last serving gNB) provide UE Context data (step 280). The old RAN node 110a fails to retrieve or verify the UE context data (step 285), and in response, indicates the failure to the new RAN node 110b (step 290). The new RAN node 110b performs a fallback to establish a new RRC connection by sending an RRCSetup message to the UE 130 (step 295), and a new connection is setup (e.g., as described in 3GPP TS 38.300 v. 15.6.0 clause 9.2.1.3.1) (step 300). Note that steps 280, 285, and 290 of FIG. 11 may, in some cases, not be executed, e.g., when the new RAN node 110b decides that it has no information about the old RAN node 110a from which the UE Context needs to be retrieved.

According to embodiments of the present disclosure, the procedure of FIG. 11 is modified at the decision point in which the new RAN node 110b decides to perform step 295 in order to execute a fallback of the RRC connection. According to this modification, the new RAN node 110b instead requests information about the old RAN node 110a from the AMF 120. In support of this modification, the new RAN node 110b stores information about the UE 130 such as its Long I-RNTI, Short I-RNTI, Resume MAC-I, Resume cause, and/or random access parameters (e.g. preamble detected, RACH configuration, contention resolution identity). Some or all of this information may be received, e.g., in an RRCResumeRequest or RRCResumeRequest1 received from the UE 130 in step 275 (examples of which have been provided above). Note that such messages carry an I-RNTI value that may be useful for this purpose.

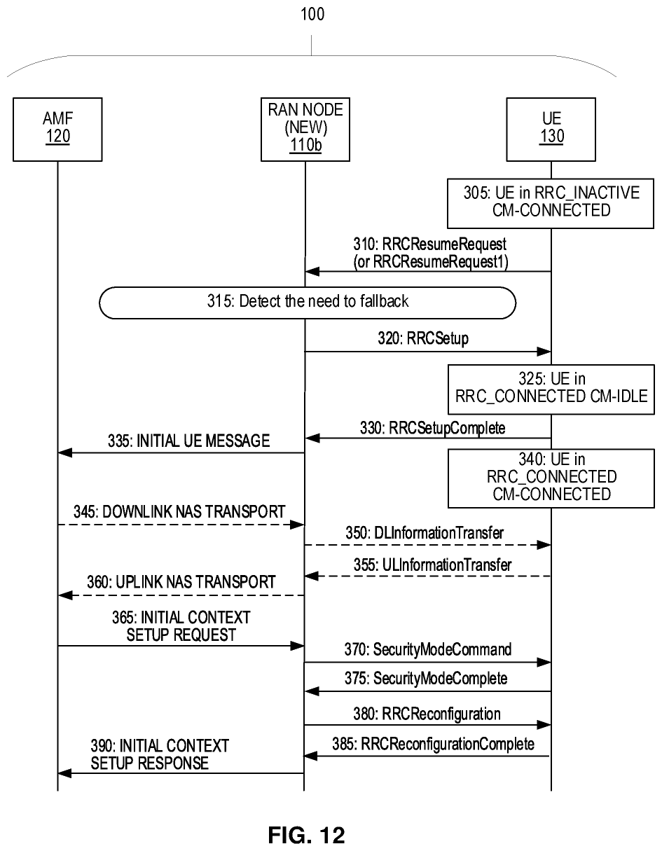

FIG. 12 illustrates an example of a trigger for exchanging information between a new RAN node 110b and an AMF 120. FIG. 12 illustrates a UE-triggered transition from RRC_INACTIVE to RRC_CONNECTED that involves a fallback from a resume attempt. The procedure shown in FIG. 12 may, according to embodiments, be interrupted and the remainder avoided by triggering the exchange of information between the new RAN node 110b and AMF 120 in accordance with embodiments described above.

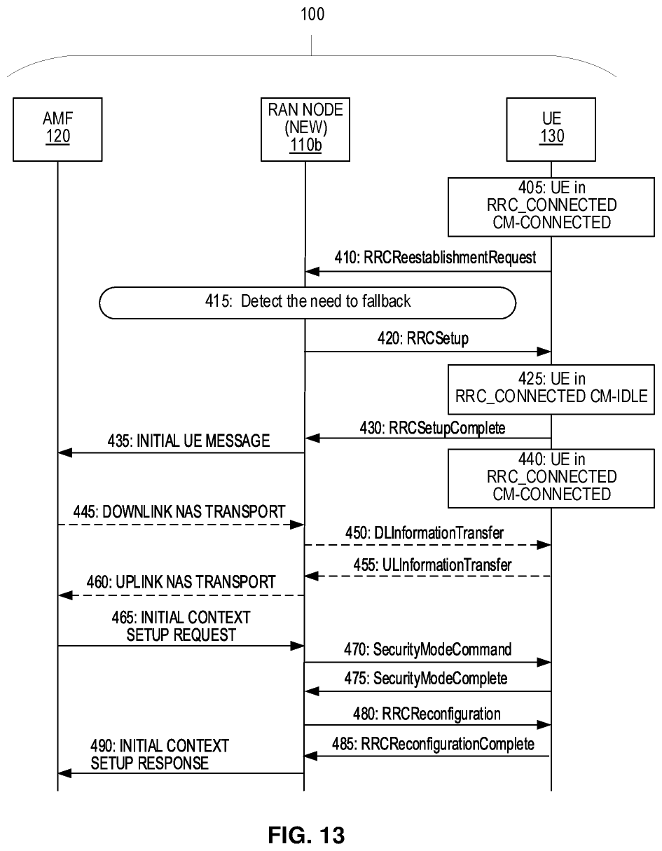

FIG. 13 illustrates an example of a different trigger for exchanging information between a new RAN node 110b and an AMF 120. FIG. 13 illustrates a UE-triggered reestablishment followed by fallback to RRC_IDLE. The procedure shown in FIG. 13 may, according to embodiments, be interrupted and the remainder avoided by triggering the exchange of information between the gNB and AMF in accordance with embodiments described above.

According to the example of FIG. 13, the UE 130 sends, to the new RAN node 110b, a Reestablishment Request that includes a PCI and a C-RNTI used in the last serving cell. The new RAN node 110b fails to retrieve the UE context (e.g., because it does not have an Xn connectivity). As described above with respect to FIG. 9, the new RAN node 110b may request that the AMF 120 provide information regarding the old RAN node 110a (e.g., the last serving gNB) so that Xn connectivity may be setup. Alternatively, as discussed above with respect to FIG. 10, the new RAN node 110b may request that the AMF 120 forward its information to the old RAN node 110a so that Xn connectivity may be setup.

According to some such embodiments as depicted in FIG. 12 or FIG. 13, upon sending the RRCResumeRequest, RRCResumeRequest1, RRCReestablishment, or similar message, and receiving an RRC Setup in response indicating that fallback is to occur, the UE 130 enters the Connected state and prepares transmission of an RRCSetupComplete message. The information received by the new RAN node 110b in the RRCSetupComplete message is correlated with information the same UE 130 has previously sent (e.g., from a RRC Resume Request message) which the new RAN node 110b previously stored. The setting of the RRC Setup Complete message according to RRC is traditionally as follows.

If upper layers provide a 5G-S-TMSI and if the RRCSetup is received in response to an RRCSetupRequest, then the ng-5G-S-TMSI-Value is set to ng-5G-S-TMSI-Part2. Otherwise, the ng-5G-S-TMSI-Value is set to ng-5G-S-TMSI.

The selectedPLMN-Identity is set to the PLMN selected by upper layers from the PLMN(s) included in the plmn-IdentityList in SIB1.

If upper layers provide the Registered AMF, then the guami-Type (set to the value provided by the upper layers) and the Registered AMF are included in the RRCSetupComplete message. If the PLMN identity of the Registered AMF is different from the PLMN selected by the upper layers, then the plmnIdentity is included in the registeredAMF set to the value of the PLMN identity in the Registered AMF received from upper layers. The amf-Identifier is set to the value received from upper layers.

If upper layers provide one or more S-NSSAI, the s-NSSAI-List is included in the RRCSetupComplete message, set to the values provided by the upper layers.

The dedicatedNAS-Message is set to include the information received from upper layers.

Having been appropriately configured, the RRCSetupComplete message is submitted to lower layers for transmission, upon which the RRCSetupComplete message generation procedure ends.

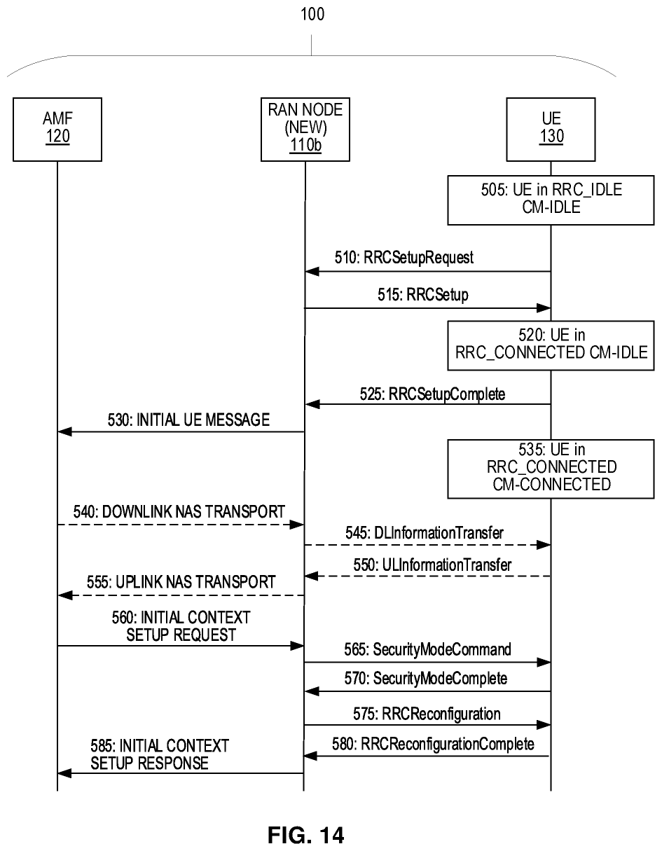

FIG. 14 illustrates setup of a new connection in which a UE triggered transition from RRC_IDLE to RRC_CONNECTED. Note that from step 515 onwards, this procedure may be valid for other triggers discussed above as well (the first message and what triggers its transmission from the UE 130 being the primary difference). The setup of this new connection resulted from the failure to retrieve a UE context.

According to the example of FIG. 14, from the RRC_IDLE state (step 505), the UE 130 requests setup of a new connection (step 510). The new RAN node 110b completes the RRC setup procedure with the UE (steps 515, 520, 525). Note that the scenario in which the new RAN node 110b rejects the request is not depicted in FIG. 14, but will be later described below.

The first NAS message from the UE 130, piggybacked in RRCSetupComplete, is sent to the AMF 120 (step 530), and the UE transitions to the RRC_CONNECTED state (step 535). According to embodiments of the present disclosure, the new RAN node 110b indicates to the AMF the stored information about the old RAN node 110a where that UE 130 was previously suspended and which currently holds the NGAP association with the AMF 120 for the UE 130 (e.g. information provided in the RRC Resume Request like message like the long I-RNTI, short I-RNTI, or parts of these like X first or last bits, resume MAC-I, etc.). That indication is a request to the AMF 120 where the new RAN node 110b expects in global information about the old RAN node 110a, which enables the new RAN node 110b to setup Xn connectivity with the old RAN node 110a. The requested information may be e.g. the Global RAN Node ID and the ‘selected TAI’ that the UE is associated with in this NGAP association.

In some embodiments, additional NAS messages may be exchanged between UE 130 and AMF 120, in accordance with 3GPP TS 23.502 (steps 540, 545, 550, 555).

The AMF 120 prepares the UE context data (including PDU session context, the Security Key, UE Radio Capability and UE Security Capabilities, etc.) and sends it to the new RAN node 110b (step 560). Given that the AMF 120 has knowledge of the old RAN node 110a (i.e., the RAN node 110 that has the NGAP association with that AMF 120 for this UE 130, which may have been identified thanks to at least one piece of information indicated from the new RAN Node 110b, like an indicated I-RNTI), the AMF 120 provides the information about the old RAN node 110a (e.g. the Global RAN Node ID and the selected TAI that the UE 130 is associated with in this NGAP association) to the new RAN node 110b. After reception of the Global RAN Node ID and the ‘selected TAI’, the new RAN node 110b can initiate setup of the Xn interface with the old RAN node 110a.

The new RAN node 110b activates the AS security with the UE (steps 565 and 570), and the new RAN node 110b performs the reconfiguration to setup signaling radio bearer 2 (SRB2) and data radio bearers (DRBs) (steps 575 and 580). The new RAN node 110b informs the AMF 120 that the setup procedure is completed (step 585).

Note that the RRC messages in steps 510 and 515 use SRB0, and all the subsequent messages use SRB1. Messages in steps 565 and 570 are integrity protected, and from step 575 on, all the messages are integrity protected and ciphered. It should be further noted that, for signaling only connection, step 575 is skipped since SRB2 and DRBs are not setup.

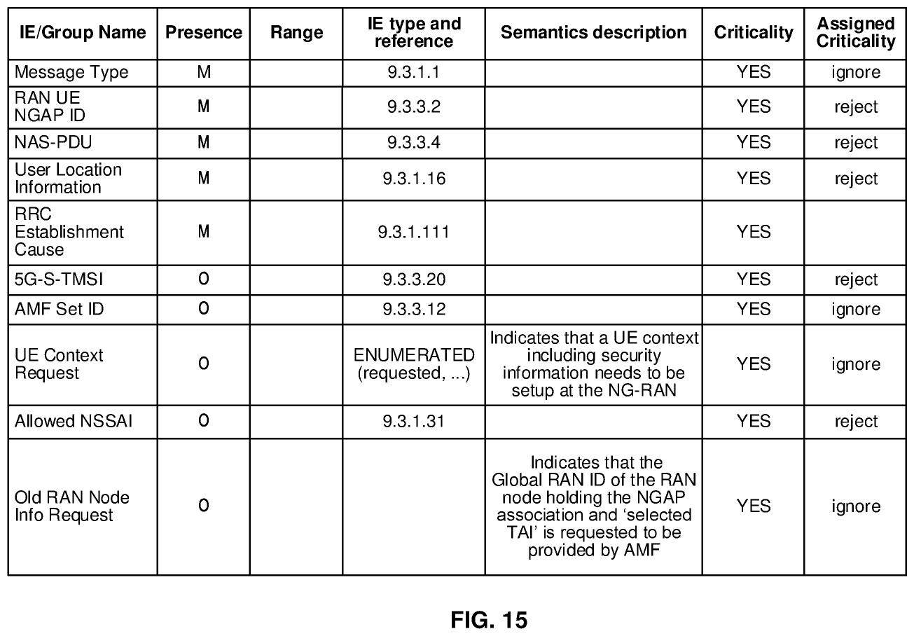

In view of the above, the INITIAL UE MESSAGE sent by the NG-RAN node to transfer the initial layer 3 message to the AMF 120 over the NG interface may be enhanced to include certain information in support of embodiments of the present disclosure. Such information may include an indication that the Global RAN ID of the RAN node holding the NGAP association and selected TAI is requested to be provided by the AMF 120. For example, the INITIAL UE MESSAGE may be structured in accordance with the table shown in FIG. 15.

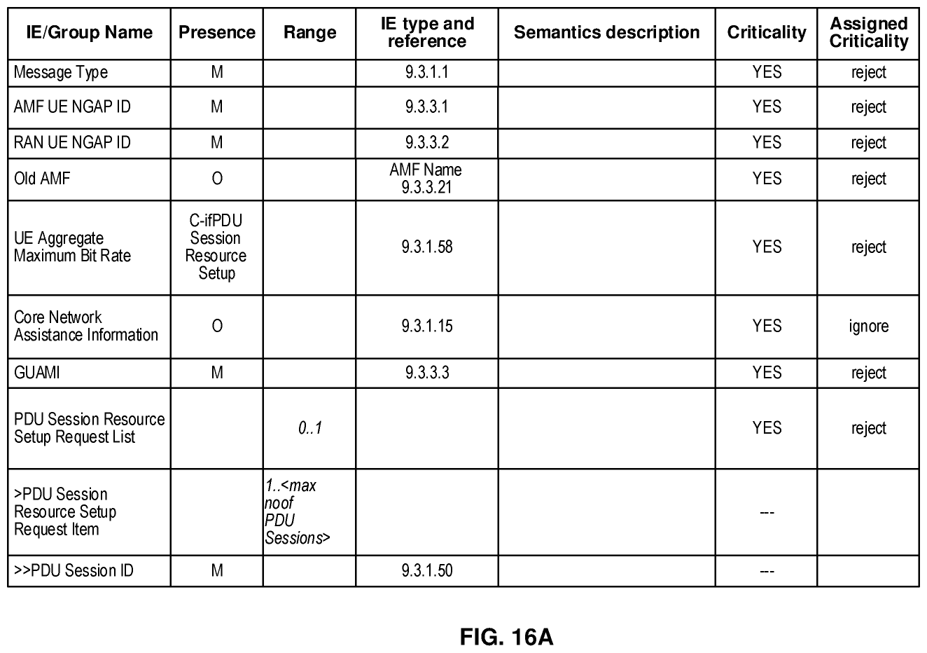

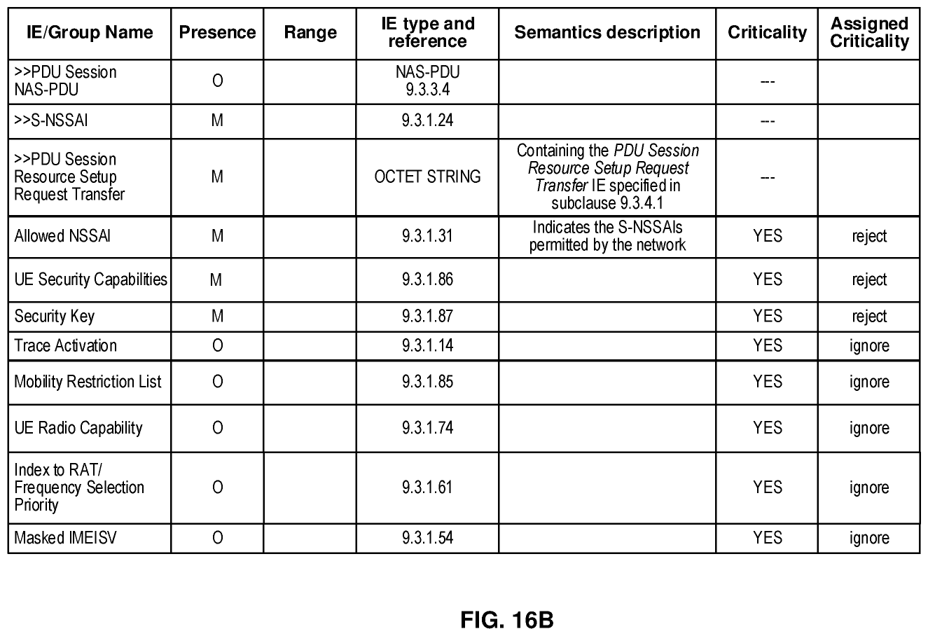

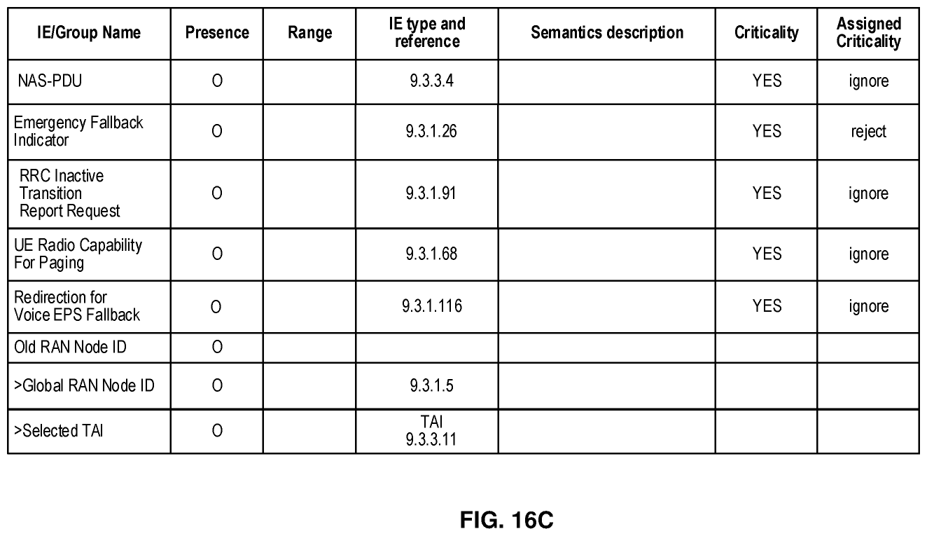

Additionally or alternatively, the INITIAL CONTEXT SETUP REQUEST message (e.g., as used in FIG. 14, step 560) may be enhanced to include an identifier of the old RAN Node 110a, which may include the Global RAN Node ID and/or selected TAI of the old RAN Node 110a. Such a message may, for example, be structured as shown in table of FIGS. 16A-C.

Note that the Range-bound maxnoofPDUSessions shown above represents the maximum number of PDU sessions allowed towards one UE 130. This value may, e.g., be set to 256.

Further, the condition ifPDUsessionResourceSetup shown above indicates that the associated IE shall be present if the PDU Session Resource Setup List IE is present.

By applying at least some of the principles described herein, a new RAN node 110b may be able to trigger an Xn setup procedure with an old RAN node 110a, regardless of whether or not the old RAN node 110a is a radio neighbor of the new RAN node 110b.

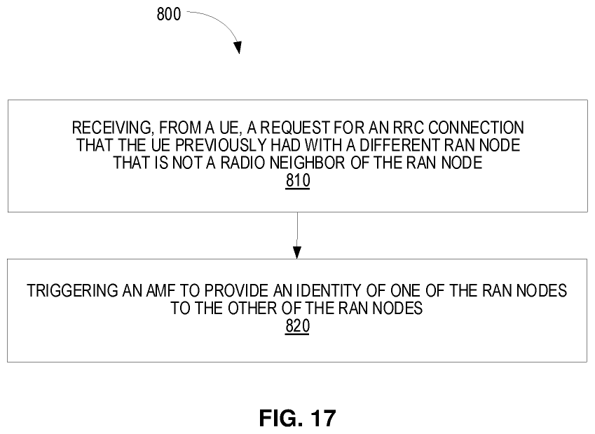

In view of all of the above, embodiments of the present disclosure include a method 800 implemented by a RAN node 110b, as shown in FIG. 17. The method 800 comprises receiving, from a UE 130, a request for an RRC connection that the UE 130 previously had with a different RAN node 110a that is not a radio neighbor of the RAN node 110b (block 810), and in response, triggering an AMF 120 to provide an identity of one of the RAN nodes 110a, 110b to the other of the RAN nodes 110a, 110b (block 820).

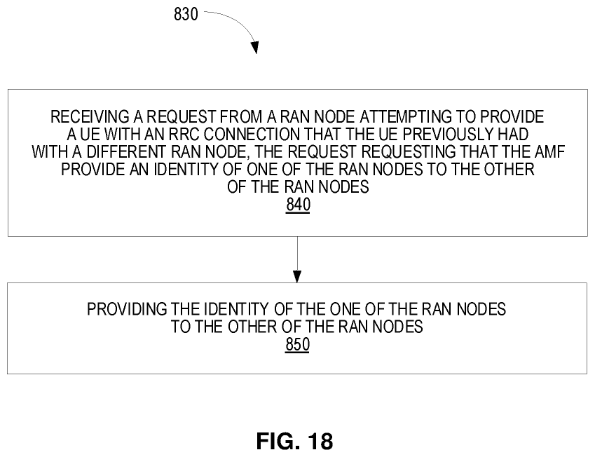

As shown in FIG. 18, embodiments of the present disclosure also include a method 830 implemented by an AMF node 120. The method 830 comprises receiving a request from a RAN node 110b attempting to provide a UE 1310 with an RRC connection that the UE 130 previously had with a different RAN node 110a, the request requesting that the AMF 130 provide an identity of one of the RAN nodes 110a, 110b to the other of the RAN nodes (block 840), and in response, providing the identity of the one of the RAN nodes 110a, 110b to the other of the RAN nodes 110a, 110b (block 850).

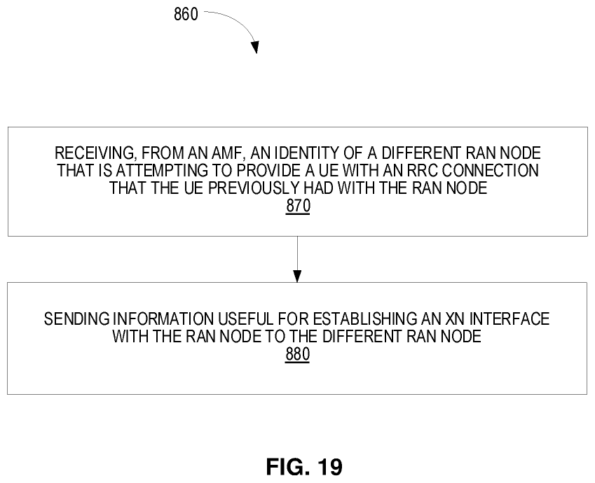

As shown in FIG. 19, embodiments of the present disclosure also include a method 860 implemented by a RAN node 110a. The method 860 comprises receiving, from an AMF 130, an identity of a different RAN node 110b that is attempting to provide a UE 130 with an RRC connection that the UE 130 previously had with the RAN node 110a (block 870), and in response, sending information useful for establishing an Xn interface with the RAN node 110a to the different RAN node 110b (block 880).

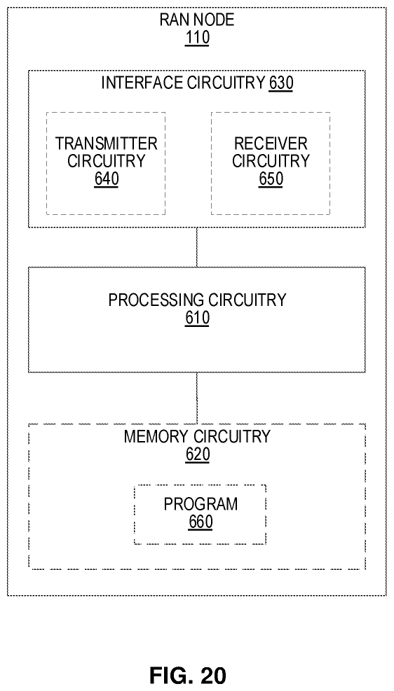

Further, as shown in FIG. 20, other embodiments include a RAN node 110. The RAN node 110 of FIG. 20 comprises processing circuitry 610 and interface circuitry 630. The processing circuitry 610 is communicatively coupled to the interface circuitry 630, e.g., via one or more buses. In some embodiments, the RAN node 110 further comprises memory circuitry 620 that is communicatively coupled to the processing circuitry 610, e.g., via one or more buses. According to particular embodiments, the processing circuitry 610 is configured to perform one or more of the methods described herein (e.g., the method 800 illustrated in FIG. 17 and/or the method 860 illustrated in FIG. 19).

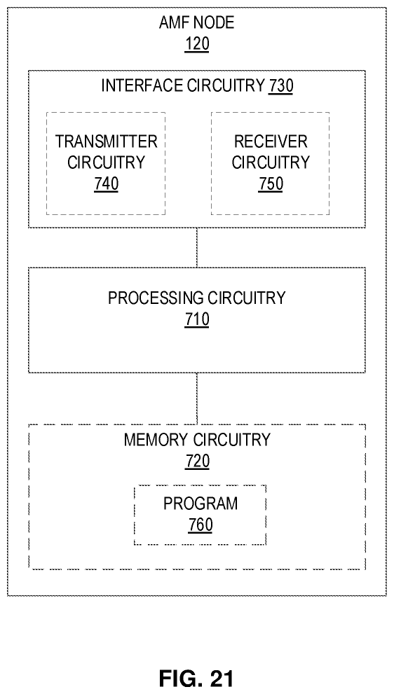

In addition, as shown in FIG. 21, other embodiments include an AMF node 120. The AMF node 120 of FIG. 21 comprises processing circuitry 710 and interface circuitry 730. The processing circuitry 710 is communicatively coupled to the interface circuitry 730, e.g., via one or more buses. In some embodiments, the AMF node 120 further comprises memory circuitry 720 that is communicatively coupled to the processing circuitry 710, e.g., via one or more buses. According to particular embodiments, the processing circuitry 710 is configured to perform one or more of the methods described herein (e.g., the method 830 illustrated in FIG. 18).

The processing circuitry 610, 710 of each device 110, 120 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 610, 710 may be programmable hardware capable of executing software instructions of a respective computer program 660, 760 stored in respective memory circuitry 620, 720 whereby the corresponding processing circuitry 610, 710 is configured. The memory circuitry 620, 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 630, 730 may be a controller hub configured to control the input and output (I/O) data paths of its respective device 110, 120. Such I/O data paths may include data paths for exchanging signals over a communications network, data paths for exchanging signals with a user, and/or data paths for exchanging data internally among components of the device 110, 120. For example, the interface circuitry 630, 730 may comprise a transceiver configured to send and receive communication signals over one or more of a cellular network, Ethernet network, or optical network. The interface circuitry 630, 730 may be implemented as a unitary physical component, or as a plurality of physical components that are contiguously or separately arranged, any of which may be communicatively coupled to any other, or may communicate with any other via the processing circuitry 610, 710. For example, the interface circuitry 630, 730 may comprise transmitter circuitry 640, 740 configured to send communication signals over a communications network and receiver circuitry 650, 750 configured to receive communication signals over the communications network. Other embodiments may include other permutations and/or arrangements of the above and/or their equivalents.

According to embodiments of the RAN node 110 illustrated in FIG. 11, the processing circuitry 610 is configured to receive, from a UE 130 via the interface circuitry 630, a request for an RRC connection that the UE 130 previously had with a different RAN node 110a that is not a radio neighbor of the RAN node 110b. The processing circuitry 610 is further configured to trigger an AMF 120 to provide an identity of one of the RAN nodes 110a, 110b to the other of the RAN nodes 110a, 110b.

According to other embodiments of the RAN node 110 illustrated in FIG. 11, the processing circuitry 610 is configured to receive, from an AMF 120 via the interface circuitry 630, an identity of a different RAN node 110b that is attempting to provide a UE 130 with an RRC connection that the UE 130 previously had with the RAN node 110a. The processing circuitry 610 is further configured to send information useful for establishing an Xn interface with the RAN node 110a to the different RAN node 110b.

According to embodiments of the AMF node 120 illustrated in FIG. 12, the processing circuitry 710 is configured to receive a request from a RAN node 110b attempting to provide a UE 130 with an RRC connection that the UE 130 previously had with a different RAN node 110a, the request requesting that the AMF node 120 provide an identity of one of the RAN nodes 110a, 110b to the other of the RAN nodes 110a, 110b. The processing circuitry 710 is further configured to provide the identity of the one of the RAN nodes 110a, 110b to the other of the RAN nodes 110a, 110b.

Other embodiments of the present disclosure include corresponding computer programs. In one such embodiment, the computer program comprises instructions which, when executed on processing circuitry of a RAN node 110, cause the RAN node 110 to carry out any of the processing described above with respect to a RAN node 110 (e.g., 110a and/or 110b). In another such embodiment, the computer program comprises instructions which, when executed on processing circuitry of an AMF node 120, cause the AMF node 120 to carry out any of the processing described above with respect to an AMF 120. A computer program in either regard may comprise one or more code modules corresponding to the means or units described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), and base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units.

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signaling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 13 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1200 may be any UE identified by the 3rd Generation Partnership Project (3GPP), including a NB-IoT UE, a machine type communication (MTC) UE, and/or an enhanced MTC (eMTC) UE. UE 1200, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 14, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

FIG. 15 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 15, hardware 1330 may be a standalone network node with generic or specific components. Hardware 1330 may comprise antenna 13225 and may implement some functions via virtualization. Alternatively, hardware 1330 may be part of a larger cluster of hardware (e.g., such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 15.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signaling can be effected with the use of control system 13230 which may alternatively be used for communication between the hardware nodes 1330 and radio units 13200.

FIG. 16 illustrates a telecommunication network connected via an intermediate network to a host computer in accordance with some embodiments. In particular, with reference to FIG. 16, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, and a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 16 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

Example implementations, in accordance with an embodiment, of the UE, base station and host computer discussed in the preceding paragraphs will now be described with reference to FIG. 17. FIG. 17 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 17) served by base station 1520. Communication interface 1526 may be configured to facilitate connection 1560 to host computer 1510. Connection 1560 may be direct or it may pass through a core network (not shown in FIG. 17) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 17 may be similar or identical to host computer 1430, one of base stations 1412a, 1412b, 1412c and one of UEs 1491, 1492 of FIG. 16, respectively. This is to say, the inner workings of these entities may be as shown in FIG. 17 and independently, the surrounding network topology may be that of FIG. 16.

In FIG. 17, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may enhance UE mobility between RAN nodes and thereby provide benefits such as reduced signaling overhead and/or latency when resuming or reestablishing RRC connections, among other things.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

FIG. 18 is a flowchart illustrating a method implemented in a communication system, in accordance with one embodiment. The communication system includes a host computer, a base station and a UE which may be those described with reference to FIG. 16 and FIG. 17. For simplicity of the present disclosure, only drawing references to FIG. 18 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIG. 16 and FIG. 17. For simplicity of the present disclosure, only drawing references to FIG. 19 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

FIG. 20 is a flowchart illustrating a method implemented in a communication system, in accordance with one embodiment. The communication system includes a host computer, a base station and a UE which may be those described with reference to FIG. 16 and FIG. 17. For simplicity of the present disclosure, only drawing references to FIG. 20 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIG. 16 and FIG. 17. For simplicity of the present disclosure, only drawing references to FIG. 21 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying appendix and/or drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1-39. (canceled)

40. A method, implemented by a new Radio Access Network (RAN) node, the method comprising:
receiving, from a UE, a resume request for an RRC connection that the UE previously had with an old RAN node, wherein the old RAN node has no existing Xn interface with the new RAN node;
in response to the resume request failing, triggering an AMF to provide an identity of the old RAN node to the new RAN node; and
establishing an Xn interface with the old RAN node using the identity of the old RAN node.

41. The method of claim 40, further comprising receiving the identity of the old RAN node in a Next Generation Application Protocol (NGAP) message.

42. The method of claim 40, wherein:
triggering the AMF to provide the identity of the old RAN node to the new RAN node comprises triggering the AMF to provide the identity of the new RAN node to the old RAN node;
the method further comprises receiving information regarding the old RAN node from the old RAN node in response to the triggering;
establishing the Xn interface with the old RAN node comprises using the information regarding the old RAN node to establish the Xn interface.

43. The method of claim 40, wherein triggering the AMF to provide the identity comprises sending an INITIAL UE message to the AMF.

44. The method of claim 40, wherein triggering the AMF to provide the identity comprises sending a Message Authentication Code-Integrity (MAC-I) received from the UE to the AMF.

45. The method of claim 40, wherein triggering the AMF to provide the identity comprises sending a Physical Cell Identifier (PCI) received from the UE to the AMF.

46. The method of claim 40, wherein triggering the AMF to provide the identity comprises sending a Radio Network Temporary Identifier (RNTI) received from the UE to the AMF.

47. The method of claim 40, further comprising receiving, from the AMF, notice that the UE has been verified as legitimate in response to the triggering.

48. A method, implemented by an Access and Mobility Function (AMF) node, the method comprising:
receiving a request from a new RAN node attempting to provide a UE with an RRC connection that the UE previously had with an old RAN node wherein the old RAN node has no existing Xn interface with the new RAN node, the request requesting, in response to a resume request for the RRC connection failing, that the AMF node provide an identity of the old RAN node to the new RAN node;
providing the identity of the old RAN node to the new RAN node for establishing an Xn interface with the old RAN node using the identity of the old RAN node.

49. The method of claim 48, wherein providing the identity of the old RAN node to the new RAN node comprises providing the identity of the old RAN node in a Next Generation Application Protocol (NGAP) message.

50. The method of claim 48, wherein providing the identity of the old RAN node to the new RAN node comprises providing the identity of the new RAN node to the old RAN node.

51. The method of claim 48, wherein receiving the request from the new RAN node comprises receiving an INITIAL UE message from the new RAN node.

52. The method of claim 48, wherein receiving the request from the new RAN node comprises receiving a Message Authentication Code-Integrity (MAC-I) from the new RAN node.

53. The method of claim 48, wherein receiving the request from the new RAN node comprises receiving a Physical Cell Identifier (PCI) from the new RAN node.

54. The method of claim 48, wherein receiving the request from the new RAN node comprises receiving a Radio Network Temporary Identifier (RNTI) from the new RAN node.

55. The method of claim 48, further comprising sending a UE verification request to the old RAN node, wherein:
the UE verification request comprises information received in the request from the new RAN node requesting that the AMF node provide the identity of one of the RAN nodes to the other of the RAN nodes; and
providing the identity of the one of the RAN nodes to the other of the RAN nodes is responsive to receiving notice from the old RAN node that the UE has been verified as legitimate.

56. A method, implemented by an old Radio Access Network (RAN) node, the method comprising:
receiving, from an AMF, an identity of a new RAN node that is attempting to provide a UE with an RRC connection that the UE previously had with the old RAN node, wherein the old RAN node has no existing Xn interface with the new RAN node;
sending information useful for establishing an Xn interface with the old RAN node to the new RAN node.

57. The method of claim 56, wherein receiving the identity of the new RAN node from the AMF comprises receiving the identity of the new RAN node in a Next Generation Application Protocol (NGAP) message.

58. The method of claim 56, further comprising receiving a Message Authentication Code-Integrity (MAC-I) from the AMF.

59. The method of claim 56, further comprising receiving a Physical Cell Identifier (PCI) from the AMF.

60. The method of claim 56, further comprising receiving a Radio Network Temporary Identifier (RNTI) from the AMF.

61. The method of claim 56, further comprising:
receiving a UE verification request from the AMF, the UE verification request comprising information received by the AMF from the old RAN node;
verifying that the UE is legitimate based on the information comprised in the UE verification request;
sending notice to the AMF that the UE is legitimate and receiving the identity of the new RAN node in response.

62. A new RAN node comprising:
processing circuitry and interface circuitry communicatively connected to the processing circuitry, wherein the processing circuitry is configured to:
receive, from a UE via the interface circuitry, a resume request for an RRC connection that the UE previously had with an old RAN node, wherein the old RAN node has no existing Xn interface with the new RAN node;
in response to the resume request failing, trigger an AMF to provide an identity of the old RAN node to the new RAN node; and
establish an Xn interface with the old RAN node using the identity of the old RAN node.

63. An AMF node comprising:
processing circuitry and interface circuitry communicatively connected to the processing circuitry, wherein the processing circuitry is configured to:
receive, via the interface circuitry, a request from a new RAN node attempting to provide a UE with an RRC connection that the UE previously had with an old RAN node wherein the old RAN node has no existing Xn interface with the new RAN node, the request requesting, in response to a resume request for the RRC connection failing, that the AMF node provide an identity of the old RAN node to the new RAN node;
provide the identity of the old RAN node to the new RAN node for establishing an Xn interface with the old RAN node using the identity of the old RAN node.

64. An old RAN node comprising:
processing circuitry and interface circuitry communicatively connected to the processing circuitry, wherein the processing circuitry is configured to:
receive, from an AMF via the interface circuitry, an identity of a new RAN node that is attempting to provide a UE with an RRC connection that the UE previously had with the old RAN node, wherein the old RAN node has no existing Xn interface with the new RAN node;
send information useful for establishing an Xn interface with the old RAN node to the new RAN node via the interface circuitry.
